(19) United States
(12) Patent Application Publication
(10) Pub. No.: US 2006/0179453 A1
(43) Pub. Date: Aug. 10, 2006

(54) Image and other analysis for contextual ads

(75) Inventors: Carl M. Kadie, Bellevue, WA (US); Joshua T. Goodman, Redmond, WA (US); Christopher A. Meek, Kirkland, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/052,394

(22) Filed: Feb. 7, 2005

(51) Int. Cl. H04N 7/10; G06F 13/00; H04N 7/025; G06F 3/00

(52) U.S. Cl. 725/34; 725/35; 725/42

(57) ABSTRACT

The subject invention provides a unique system and method that facilitates providing contextual advertisements based on one or more identified terms extracted from a non-text object such as an image, video, and/or audio object. Terms can also be identified and extracted from metadata associated with or other data derived from text objects such as email messages and attached text documents. One or more recognition techniques can be employed to identify data found in the non-text object (including the metadata or any other data derived therefrom) and data found in the metadata associated with the text object. Once the identified terms are analyzed, an appropriate contextual advertisement can be presented to the user. If the content of the non-text or text object is deemed of a negative nature, no contextual advertisement is provided.

### TECHNICAL FIELD

The subject invention relates generally to online advertising and in particular to the presentation of contextual advertisements, the content of which is determined at least in part by content associated with a non-textual file and/or by metadata associated with a computer file.

### BACKGROUND OF THE INVENTION

Advertising in general is a key revenue source in just about any commercial market or setting. To reach as many consumers as possible, advertisements are traditionally presented via billboards, television, radio, and print media such as newspapers and magazines. However, with the advent and rise of the Internet, advertisers have found a new and perhaps less expensive medium for reaching vast numbers of potential customers across a large and diverse geographic span. Advertisements on the Internet can primarily be seen on web pages or web sites as well as in pop-up windows when a particular site is visited.

In addition to such generic web site advertising, businesses interested in finding new customers and generating revenues continue to look for atypical channels that may be suitable for posting advertisements. One current delivery mode, for example, involves attaching an advertisement to an incoming email for the recipient of the email to view. The type or subject matter of the advertisement may be selected according to text included in the body of the message. Despite the current delivery mode of advertisements, there remains a need to provide the most appropriate advertisement that is most relevant and helpful to a user at any given time.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to a system and/or methodology that facilitate providing contextual advertisements to users when viewing non-text files or objects such as images, audio objects, video streams, and text files (text objects) such as electronic or instant messages and/or any application file. Examples of images can include pictures, drawings, photographs, video stills, scanned documents, and/or web-based fax document images. In the case of non-text files, the system and method can extract some information from the image, audio file, or video stream by employing one or more recognition techniques. For example, optical character recognition (OCR) can be used to recognize and identify the words “Laguna Beach” that appear in a photograph being viewed by the user. Consequently, an advertisement for beach attire and equipment can be presented to the user. Additional information such as the user profile and the user's demographic and geographic location can also be considered when determining the most relevant advertisement for the user while viewing a particular file or object.

Both text and non-text files can have information known as metadata associated therewith or embedded therein. When a user is viewing a file such as an attachment of a transferred file (e.g., word processing document or spreadsheet), the metadata, or a portion thereof, associated with the file can be analyzed using one or more recognition techniques to identify relevant terms. For example, imagine that a user has received a drawing file from his architect of the user's new home. The metadata of the drawing file or the image in the drawing itself may indicate that the drawing was made using a building plan template. Thus, an advertisement for a mortgage broker can be shown to the user.

In some instances, presenting advertisements may be inappropriate given the file or object currently being viewed by the user. For example, viewing a photograph of a burning house or of a car accident scene generally may not warrant receiving advertisements for a new home builder or a collision repair shop. Advertisers generally do not want advertisements shown when a user is viewing pornographic or sexually explicit photos. Thus, the subject invention can also include a detector or related component that determines or verifies that an advertisement is appropriate according to a sensitivity detector that may analyze the identified terms or objects extracted from the file. Alternatively or in addition, the sensitivity detector may analyze other related material, such as text near the file. Alternatively, the user can have the option to deactivate this sensor and always be shown advertisements when available.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a system that facilitates non-text object analysis to provide contextual advertisements in accordance with an aspect of the subject invention.

FIG. 2 is a block diagram of a system that facilitates non-text object and text object analyses to provide contextual advertisements in accordance with another aspect of the subject invention.

FIG. 3 is a block diagram demonstrating the transfer or remote access of non-text or text objects to or by a user that triggers contextual advertisements to be shown to the user in accordance with yet another aspect of the subject invention.

FIG. 4 is an exemplary photo image from which data can be extracted or derived therefrom to facilitate the selection of a contextual advertisement in accordance with still another aspect of the subject invention.

FIG. 5 is an exemplary fax image or attachment from which data can be extracted or derived therefrom to facilitate the selection of a contextual advertisement in accordance with an aspect of the subject invention.

FIG. 6 is a flow chart illustrating an exemplary methodology that facilitates analyzing objects in view by a user to determine which contextual advertisement to show a user in accordance with an aspect of the subject invention.

FIG. 7 is a flow chart illustrating an exemplary methodology that facilitates analyzing objects in view by a user to determine which contextual advertisement to show a user in accordance with an aspect of the subject invention.

FIG. 8 illustrates an exemplary environment for implementing various aspects of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject invention can incorporate various inference schemes and/or techniques in connection with selecting at least one contextual advertisement to be presented to a user. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic - that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

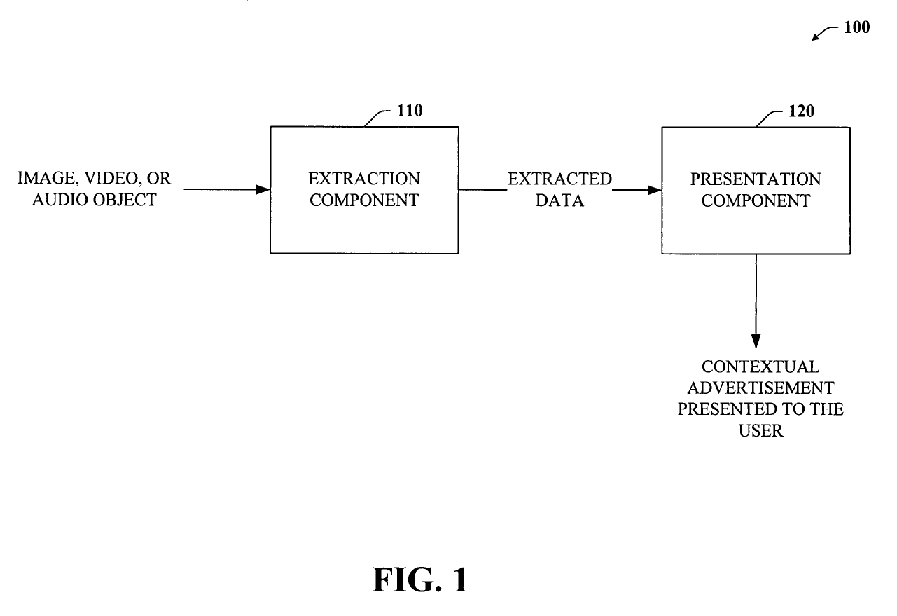

Referring now to FIG. 1, there is a general block diagram of a contextual based advertising system 100 in accordance with an aspect of the subject invention. The advertising system 100 includes an extraction component 110 that can extract data from an image, video, or audio object and based on this data or other information derived therefrom, a presentation component 120 can select and show a contextual advertisement to a user that is relevant in some way to the audio or image object that is being viewed or that was recently opened by the user. For example, imagine that the user has uploaded a video of his/her newborn to share with other family members. Using a recognition technique commonly known as word spotting on the video's sound track, the system 100 can identify the words “baby” and “newborn” and as a result, can show the user an advertisement for diapers or some other baby-related product or service. Additional information can also be considered when selecting a contextual advertisement. This information can include the user's profile and/or the user's demographic and/or geographic information.

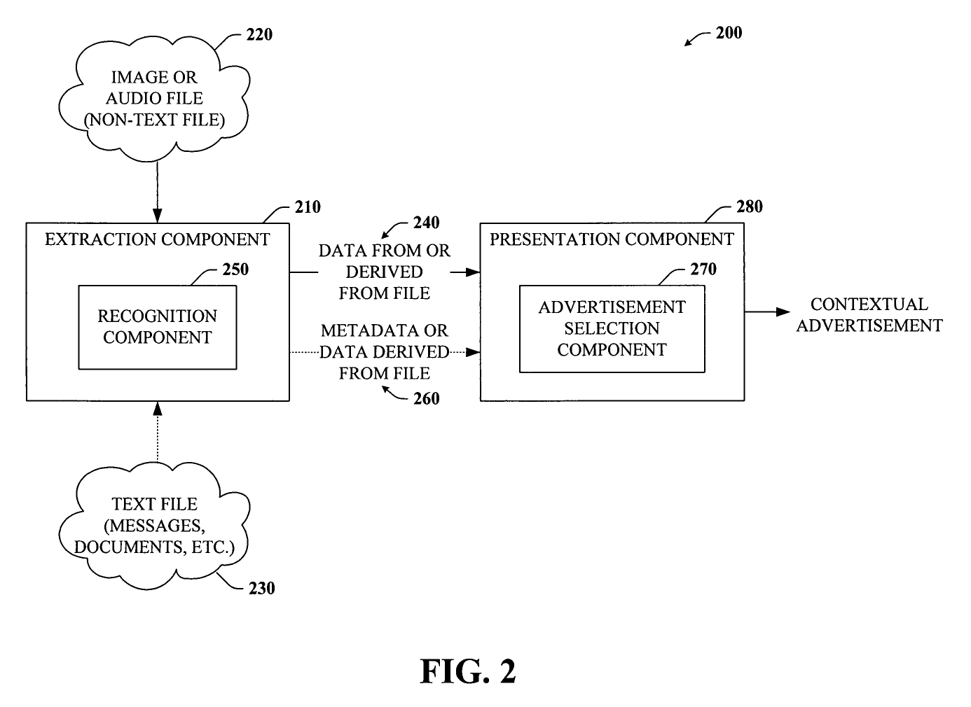

Referring now to FIG. 2, there is illustrated a block diagram of a contextual advertising system 200 in accordance with an aspect of the subject invention. The system 200 includes an extraction component 210 that can extract information from a non-text 220 file and/or a text file 230. For instance, information (240) can be extracted from the actual content of non-text files through the use of a recognition component 250. The recognition component 250 can employ one or more recognition techniques to identify words, character strings, objects, patterns, speech, and/or templates included in an image, video, and/or audio file. Thus, a photo sent as an email attachment can be analyzed for what is contained in the image of the photo—in addition to any metadata associated with the photo such as the title of the image file, type of image file (e.g., jpg, gif, etc.), GPS coordinates (e.g., longitude and latitude), creation time and/or last time modified, camera type, compression type and parameters, and/or duration, etc.

By contrast, text files can be analyzed for their metadata information or other data derived therefrom (260) rather than for the actual content contained in the body of the file. For example, suppose that a user receives a word processor document as an email attachment. One or more portions of metadata embedded within or associated with the document can be extracted and identified using the recognition component 250. In addition to the types of metadata described, supra, metadata can also include added keywords, file size, watermarks, file format, file type, and author or creator of the file.

Hence, the recognition component 250 can identify one or more terms from information extracted from the non-text 220 or text file 230. The identified terms can then be used to determine which contextual advertisement is selected to be shown to the user. In particular, an advertisement selection component 270 can select at least one contextual advertisement for the given non-text or text file being viewed by the user. Once selected, a presentation component 280 can present or show the advertisement to the user. In practice, for example, the contextual advertisement can appear in a new window or in a pop-up window while the file is being viewed.

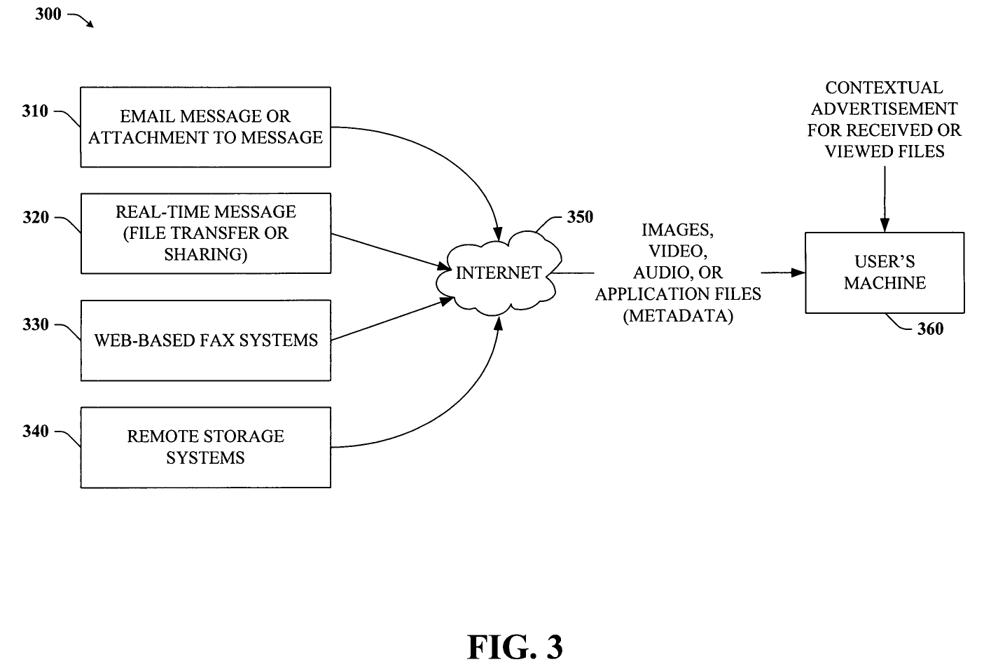

Turning now to FIG. 3, there is a block diagram that demonstrates a relationship or interaction 300 between the sources and types of files and the presentation of contextual advertisements based on the files viewed or accessed by a user. The various types of files to which content targeting and contextual advertising can be applied includes an email message or an attachment to a message (310), a file that is received or sent via instant messaging (320), images of faxes retrieved from a web-based fax system (330), and/or remote storage systems (340) such as file back-up and recovery systems, an array of commodity computers used to cheaply store data, and shared file systems. In particular, the file might be shared on a free or low-cost web-based file sharing system (340), such as a picture sharing site, or a blogging site that allows sharing pictures or audio files. The site owner displays ads based on the content of the images shared by the sites users. Any one of these files can be communicated across or by way of the internet 350 and to a user's machine 360. For instance, images, video, audio, and/or application files can be communicated to the user's machine via the Internet. Once the relevant information has been analyzed, one or more contextual advertisements can be shown to the user, which are relevant and related to the analyzed information.

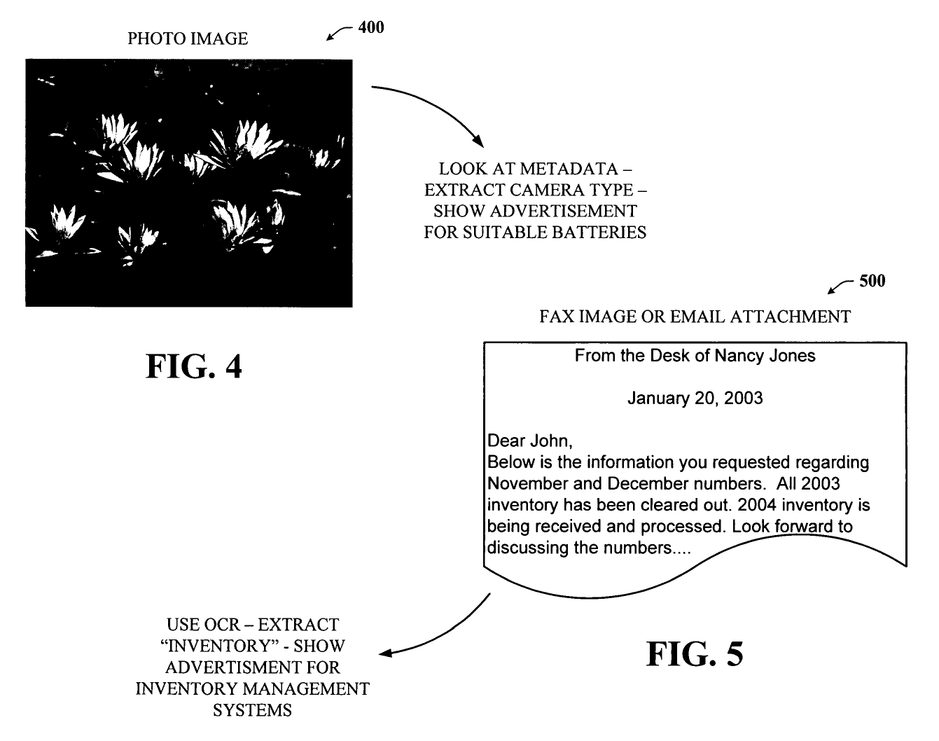

In FIGS. 4 and 5 that follow, exemplary files or objects are depicted in accordance with an aspect of the subject invention. FIG. 4 illustrates a photo image that may have been uploaded to a photo sharing site by the user. By looking at the metadata associated with the image, the camera type (e.g., type of camera that captured and recorded the image) can be identified. As a result, a contextual advertisement for batteries suited for the identified camera type can be presented to the user. In this particular instance, the user can be described as “sending” an image file to a remote location (e.g., the Web). Thus, contextual advertisements can be presented to the user as a result of receiving or sending a file or object.

In FIG. 5, there is represented an exemplary fax image or email attachment. OCR can be employed to identify the term “inventory” to cause a contextual advertisement for inventory management systems to be shown to the user. The user may want to share the fax image with another person via email. Thus, the receiver of the message may also receive and view such contextual advertisements.

Various methodologies in accordance with the subject invention will now be described via a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

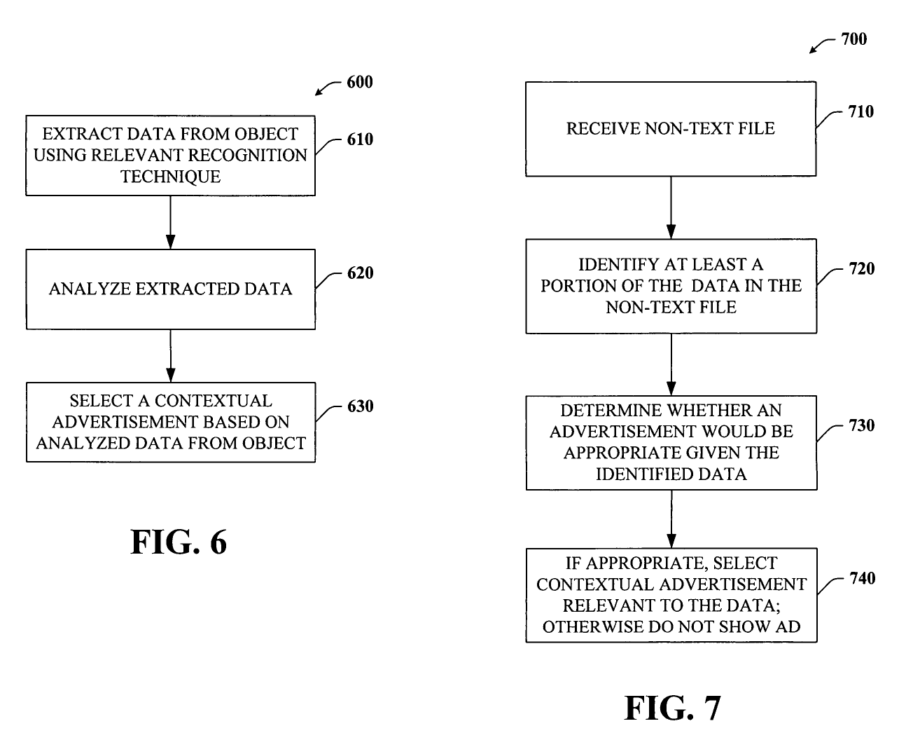

Referring now to FIG. 6, there is a flow diagram of an exemplary method 600 that facilitates providing contextual advertisements based on content extracted from non-text objects and based on content extracted from metadata associated with text objects. The method 600 involves extracting data from an object using a relevant recognition technique at 610. For example, imagine that a user is viewing a photograph taken during a recent vacation to Yosemite National Park. The words “Yosemite National Park” can be identified in the photograph using OCR. Or imagine that a user is listening to an audio file containing speech. A speech recognition system can determine the words in the file and use this for targeting ads. Or imagine that a user is listening to a music file. A signature system may be used to determine what song is being listened to and to target ads for other songs by the same artist or in the same genre. Such signature systems can be used with other file types, including image and video file types. At 620, the extracted data can be analyzed to facilitate selecting a contextual ad based at least in part on the extracted data (e.g., Yosemite National Park). At 630, a contextual advertisement can be selected and presented to the viewer of the photograph.

In the case of a text object such as an email or a letter included as an attachment that is being viewed by the user, metadata associated with the text object or other data derived therefrom can be extracted and identified using a recognition technique as OCR. Hence, the content of the letter or email itself is not considered or analyzed for the purpose of selecting a contextual advertisement.

Referring now to FIG. 7, there is a flow diagram of an exemplary process 700 that facilitates providing a contextual advertisement for non-text files such as images, audio, and/or video objects. The process 700 includes receiving a non-text file at 710. The non-text file can be received as soon as the file is opened by a user. At 720, at least a portion of data in the non-text file can be identified using one or more recognition techniques. In addition to the information included in the non-text file, other information can be considered as well. This can include information about the user extracted from the user. User profile information can include geographic information about the user; demographic information about the user; or behavioral information, such as activities of the user, websites visited, and other advertisements the user may have responded to.

At 730, the process 700 can determine whether a contextual advertisement would be appropriate given the data identified in the file. This can be important considering that providing a contextual advertisement may not always be the most appropriate action to take. For example, reading a web-based fax document regarding a family member's funeral arrangements may cause a contextual advertisement about florists specializing in such arrangements. However, some users may not wish to see or may not be interested in receiving advertisements about floral arrangements at that particular time. Thus, if the context of the content is deemed to be of a “sensitive” or negative nature, the process 700 may automatically forego selecting and showing the advertisement. However, if an advertisement is determined to be appropriate, then a contextual advertisement relevant to at least the identified data can be presented at 740.

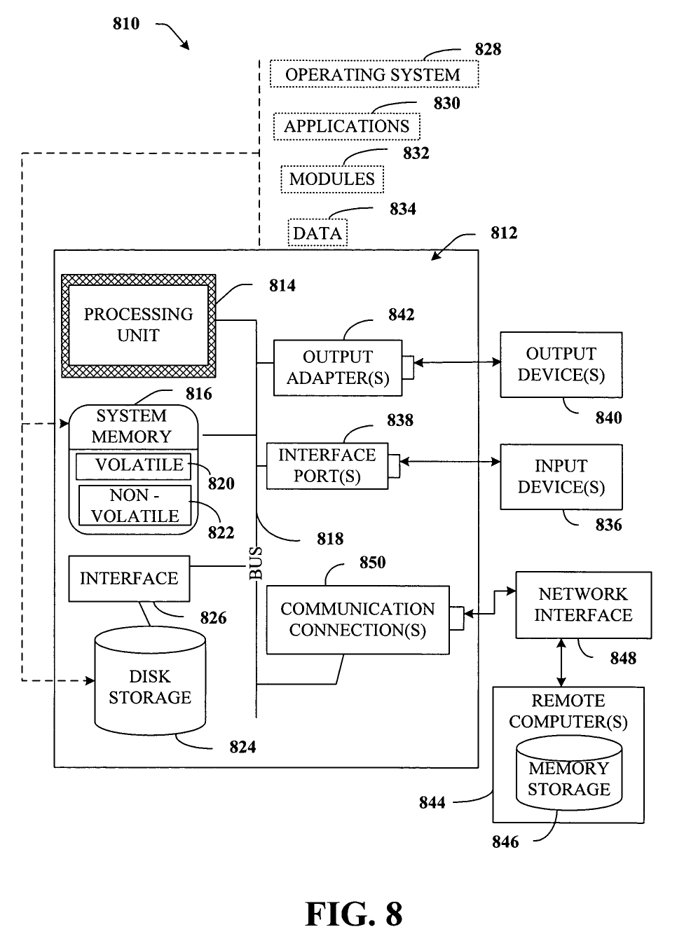

In order to provide additional context for various aspects of the subject invention, FIG. 8 and the following discussion are intended to provide a brief, general description of a suitable operating environment 810 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 810 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/nonremovable, volatile/nonvolatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the subject invention can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812 and to output information from computer 812 to an output device 840. Output adapter 842 is provided to illustrate that there are some output devices 840 like monitors, speakers, and printers among other output devices 840 that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A contextual-based advertising system comprising:
an extraction component that extracts and analyzes at least a portion of data from at least one of an image object, a video object, an audio object, and the metadata section of a file; and
a presentation component that determines at least one contextual advertisement to present to a user based at least in part on information extracted from the image, video, or audio object.

2. The system of claim 1, the data extracted comprises data derived from the video object.

3. The system of claim 1, the data extracted comprises data derived from the audio object.

4. The system of claim 1, the data is received via a messaging system comprising at least one of instant messaging, chat, email, or file sharing.

5. The system of claim 1, the data is stored on a remote file storage system which serves the advertisements.

6. The system of claim 1, wherein audio data is targeted via speech recognition.

7. The system of claim 1, wherein the audio data is targeted via matching fingerprints to known content.

8. The system of claim 1, the presentation component analyzes at least a portion of user profile information to facilitate selecting the contextual advertisement.

9. The system of claim 1, the image object comprises any one of the following: picture, photograph, scene, video, drawing, and facsimile image.

10. The system of claim 1, further comprising a sensitivity sensor that verifies that a presentation of a contextual advertisement is appropriate.

11. The system of claim 1, the extraction component extracts data from at least one of a non-text object and a text object, the non-text object comprising any one of an image object or an audio object and the text object comprising encrypted messages, HTML messages, binary-encoded messages, documents, computer-based files, and application files.

12. The system of claim 1, the extraction component extracts a text portion of the metadata comprising object name, author, keywords, or other textual metadata.

13. The system of claim 1, the metadata comprising at least one of the following: object type, creation date, duration, object size, last date modified, object recording type, compression type, GPS coordinates, time of recording, object format, and/or watermarks.

14. A method that facilitates contextual-based advertising comprising:
extracting at least a portion of data from a non-text object;
analyzing the data extracted from the non-text object to ascertain its content; and
determining at least one contextual advertisement to present to a user based at least in part on the content of the data extracted from the non-text object.

15. The method of claim 14, the non-text object comprises an image object.

16. The method of claim 14, the non-text object comprises an audio object.

17. The method of claim 14, the non-text object comprises a video object.

18. The method of claim 14, the data extracted from the non-text object comprises content in the non-text object, metadata associated with the object, and data derived therefrom.

19. The method of claim 14, further comprising analyzing at least a portion of user profile information.

20. A contextual-based advertising system comprising:
means for extracting and analyzing at least a portion of data from at least one of an image object, a video object, an audio object, and the metadata section of a file; and
means for determining at least one contextual advertisement to present to a user based at least in part on information extracted from the image, video, or audio object.
